(19) United States
(12) Patent Application Publication
(10) Pub. No.: US 2009/0042097 A1
(43) Pub. Date: Feb. 12, 2009

(54) NEGATIVE ELECTRODE CURRENT COLLECTOR FOR LITHIUM ION SECONDARY BATTERY, NEGATIVE ELECTRODE FOR LITHIUM ION SECONDARY BATTERY, AND LITHIUM ION SECONDARY BATTERY

(76) Inventors: Masato Fujikawa, Osaka (JP); Hideharu Takezawa, Nara (JP); Shinji Kasamatsu, Osaka (JP); Tomohiko Yokoyama, Osaka (JP)

Correspondence Address: MCDERMOTT WILL & EMERY LLP, 600 13TH STREET, NW, WASHINGTON, DC, 20005-3096, US

(21) Appl. No.: 12/187,736

(22) Filed: Aug. 7, 2008

(30) Foreign Application Priority Data
Aug. 9, 2007 (JP) 2007-208499

(51) Int. Cl. H01M 4/02; H01M 10/00

(52) U.S. Cl. 429/129; 429/209; 429/218.1

(57) ABSTRACT

A lithium ion secondary battery includes a negative electrode that is shaped like waves in a section in the thickness direction. In the negative electrode, the ratio t1/t0 of the largest thickness t1 to the smallest thickness t0 is from 1.2 to 3.0. The negative electrode includes a thin-film negative electrode active material layer in which the ratio A/B of the volume A in a charged state to the volume B in a discharged state is 1.2 or more. The lithium ion secondary battery has high capacity, high power, long life, and improved safety. In particular, heat generation due to an internal short-circuit is significantly suppressed in a nail penetration test.

### FIELD OF THE INVENTION

The invention relates to a negative electrode current collector for a lithium ion secondary battery, a negative electrode for a lithium ion secondary battery, and a lithium ion secondary battery. More particularly, the invention mainly relates to improvements in the negative electrode.

### BACKGROUND OF THE INVENTION

Lithium ion secondary batteries have high capacity and high energy density, and their size and weight can be easily reduced. Thus, they are widely used as the power source for portable small-sized electronic devices. Examples of portable electronic devices include cellular phones, personal digital assistants (PDAs), notebook personal computers, video cameras, and portable game machines.

A typical lithium ion secondary battery includes an electrode assembly composed of: a positive electrode comprising a positive electrode active material layer containing a lithium cobalt compound and formed on the surface of an aluminum foil (positive electrode current collector); a separator made of a polyolefin porous film; and a negative electrode comprising a negative electrode active material layer containing a carbon material and formed on the surface of a copper foil (negative electrode current collector). The electrode assembly is housed in a battery can. This battery has high capacity, high power, and long life.

The recent remarkably widespread use of portable electronic devices has promoted the increase in functionality of portable electronic devices. As a result, it is desired to further heighten the capacity of lithium ion secondary batteries. To achieve this, for example, high-capacity negative electrode active materials are being developed.

As high-capacity negative electrode active materials, alloy-type negative electrode active materials have been receiving attention. An alloy-type negative electrode active material is a substance capable of absorbing lithium by being alloyed with lithium and capable of reversibly absorbing and desorbing lithium. Examples of alloy-type negative electrode active materials include silicon, tin, oxides thereof, and compounds and alloys containing such materials. Alloy-type negative electrode active materials have high discharge capacities. For example, the theoretical discharge capacity of silicon is approximately 4199 mAh/g, which is approximately 11 times higher than the theoretical discharge capacity of graphite, which is a conventional negative electrode active material. Hence, alloy-type negative electrode active materials are effective for heightening the capacity of lithium ion secondary batteries.

However, batteries using alloy-type negative electrode active materials have a problem to be solved. That is, in the event of an internal short-circuit, they produce large amounts of heat and tend to heat up to high temperatures. For example, assume that a nail is stuck into a battery. First, the nail causes an internal short-circuit between the positive and negative electrodes, thereby generating Joule's heat. The amount of heat generation is particularly large in the contact area of the nail and the current collectors of the positive and negative electrodes, having low resistance. The temperature locally reaches 600° C. or more, thereby resulting in melting of the positive electrode current collector made of aluminum whose melting point is 660° C. Thus, the short-circuit around the nail disappears. However, the heat generation causes the separator to shrink, which in turn causes a short-circuit between the active material layers of the positive and negative electrodes. At this time, when the negative electrode active material is an alloy-type negative electrode active material, a large amount of heat is locally generated, and the battery tends to heat up to a high temperature.

Also, when an alloy-type negative electrode active material absorbs lithium, it expands due to a large change in crystal structure, thereby causing a plastic deformation of the negative electrode current collector, such as wrinkles or warpage of the negative electrode current collector. The deformation of the negative electrode current collector also causes deformation of the negative electrode. Excessive deformation of the negative electrode current collector and the negative electrode causes a series of problems, such as separation of the negative electrode active material layer from the negative electrode current collector, a decrease in electronic conductivity between the negative electrode current collector and the negative electrode active material layer, degradation of battery performance such as cycle characteristics. Because of such problems, in conventional lithium ion secondary batteries, attempts have been made to minimize the occurrence of deformation of the negative electrode current collector such as wrinkles or warpage.

With respect to negative electrodes containing alloy-type negative electrode active materials or lithium ion secondary batteries including such negative electrodes, various techniques have been proposed to prevent negative electrode deformation. Japanese Laid-Open Patent Publication No. 2005-038797 discloses a negative electrode including: a negative electrode current collector made of a metal not alloyable with lithium, having protrusions and depressions on the surfaces, and having an effective thickness of 15 to 300 μm; and a thin-film negative electrode active material layer containing an alloy-type negative electrode active material. As used herein, the effective thickness refers to the distance from the bottom of the depressions to the top of the protrusions.

Also, Japanese Laid-Open Patent Publication No. 2005-285651 discloses a negative electrode including: a negative electrode current collector having protrusions and depressions on the surfaces; and a negative electrode active material layer containing an alloy-type negative electrode active material. In this negative electrode, the ratio of the thickness (μm) of the negative electrode active material layer to the 10-point average roughness Rz (μm) of the negative electrode current collector surface is from 0.5 to 4, and the ratio of (the tensile strength (N/mm²) of the negative electrode current collector at 25° C.×the base thickness (μm) of the negative electrode current collector) to the thickness (μm) of the negative electrode active material layer is 2 or more.

According to these conventional techniques, by forming the protrusions and depressions on the negative electrode current collector surface, the stress exerted by expansion of the alloy-type negative electrode active material is reduced. However, merely forming the protrusions and depressions on the negative electrode current collector surface does not permit reduction or prevention of significant heat generation in the event of an internal short-circuit of the battery. Also, although these conventional techniques set the thickness of the negative electrode current collector or negative electrode active material layer to a specific range, they are silent as to technical concept of setting the thickness of the whole negative electrode.

Further, Japanese Laid-Open Patent Publication No. 2006-260928 proposes a technique in which a tensile load is applied to a negative electrode including a thin film containing an alloy-type negative electrode active material and a negative electrode current collector to cause a plastic deformation of the negative electrode current collector. This conventional technique intends to reduce the stress exerted by the expansion of the alloy-type negative electrode active material, which can cause deformation of the negative electrode, by applying a tensile load to the negative electrode. However, even the use of the negative electrode disclosed by this conventional technique does not permit reduction or prevention of significant heat generation in the event of an internal short-circuit of the battery.

### BRIEF SUMMARY OF THE INVENTION

An object of the invention is to provide a lithium ion secondary battery including an alloy-type negative electrode active material and having high capacity, high power, and long life, wherein even under abnormal conditions such as an internal short-circuit, the battery does not produce large heat and is unlikely to heat up to a high temperature.

The inventors have conducted studies to solve the problems discussed above. They have found that a negative electrode active material layer containing an alloy-type negative electrode active material can provide a high capacity and contribute to providing a battery with a high energy density, even if the whole surface of the negative electrode active material layer in the thickness direction does not face the surface of a positive electrode active material layer at an equal distance with a separator interposed therebetween. Based on this finding, the inventors have conducted further studies and found a negative electrode structure in which the whole negative electrode is moderately wavy or corrugated, despite the fact that in conventional techniques, attempts have been made to minimize the use of deformed negative electrode current collectors. Further, having found that the use of such a negative electrode can provide a desired lithium ion secondary battery, the inventors have completed the invention.

The invention relates to a negative electrode for a lithium ion secondary battery including: a negative electrode current collector; and a thin-film negative electrode active material layer formed on the negative electrode current collector. The ratio A/B of the volume A of the negative electrode active material layer in a charged state to the volume B of the negative electrode active material layer in a discharged state is 1.2 or more. The negative electrode is shaped like waves in a section in the thickness direction. The ratio t1/t0 of the largest thickness t1 of the negative electrode to the smallest thickness t0 of the negative electrode is from 1.2 to 3.0.

The wave pitch in the section of the negative electrode in the thickness direction is preferably 0.3 to 3 mm.

The smallest thickness to is preferably 30 to 150 μm.

The thin-film negative electrode active material layer preferably includes a silicon-containing compound or a tin-containing compound.

In another mode, the thin-film negative electrode active material layer preferably includes a plurality of columns containing a silicon-containing compound or a tin-containing compound.

Preferably, the plurality of columns extend outwardly from a surface of the negative electrode current collector and are spaced apart from one another.

Preferably, the columns extend in a direction perpendicular to a surface of the negative electrode current collector or extend slantwise relative to the direction perpendicular to the surface of the negative electrode current collector.

Each of the columns is preferably a laminate of particles containing a silicon-containing compound or a tin-containing compound.

The silicon-containing compound is preferably one or more selected from the group consisting of silicon, silicon oxides, silicon nitrides, silicon-containing alloys, and silicon compounds.

The tin-containing compound is preferably one or more selected from the group consisting of tin, tin oxides, tin nitrides, tin-containing alloys, and tin compounds.

The invention also relates to a lithium ion secondary battery including: a positive electrode capable of absorbing and desorbing lithium; the negative electrode of the invention; a separator, and a non-aqueous electrolyte.

The lithium ion secondary battery of the invention including the negative electrode of the invention has high capacity, high power, excellent battery performance such as cycle characteristics, and long battery life. Also, the lithium ion secondary battery of the invention has a very high level of safety despite the use of a high-capacity alloy-type negative electrode active material. For example, even if an internal short-circuit occurs, it is unlikely to expand, and the heat generation is markedly suppressed.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a schematic longitudinal sectional view of the structure of a lithium ion secondary battery in one embodiment of the invention;

FIG. 2 is an enlarged longitudinal sectional view of the structure of a negative electrode included in the lithium ion secondary battery illustrated in FIG. 1;

FIG. 3 is a schematic longitudinal sectional view of the structure of a negative electrode in another embodiment;

FIG. 4 is a schematic longitudinal sectional view of the structure of a column included in a negative electrode active material layer of the negative electrode illustrated in FIG. 3;

FIG. 5 is a schematic longitudinal sectional view of the structure of a negative electrode in another embodiment;

FIG. 6 is a schematic side view of the structure of an electron beam deposition device; and

FIG. 7 is a schematic side view of the structure of a deposition device in another embodiment.

### DETAILED DESCRIPTION OF THE INVENTION

The lithium ion secondary battery of the invention includes a positive electrode, a negative electrode, a separator, and a non-aqueous electrolyte. The lithium ion secondary battery of the invention is characterized by its negative electrode. The negative electrode is characterized in that it contains an alloy-type negative electrode active material as the negative electrode active material, and that it is shaped like waves in a section in the thickness direction. The lithium ion secondary battery of the invention including this negative electrode has high capacity, high power, excellent battery performance such as cycle characteristics, long battery life, and high safety.

The lithium ion secondary battery of the invention can employ the same constitution as that of a conventional lithium ion secondary battery except for the use of the aforementioned negative electrode.

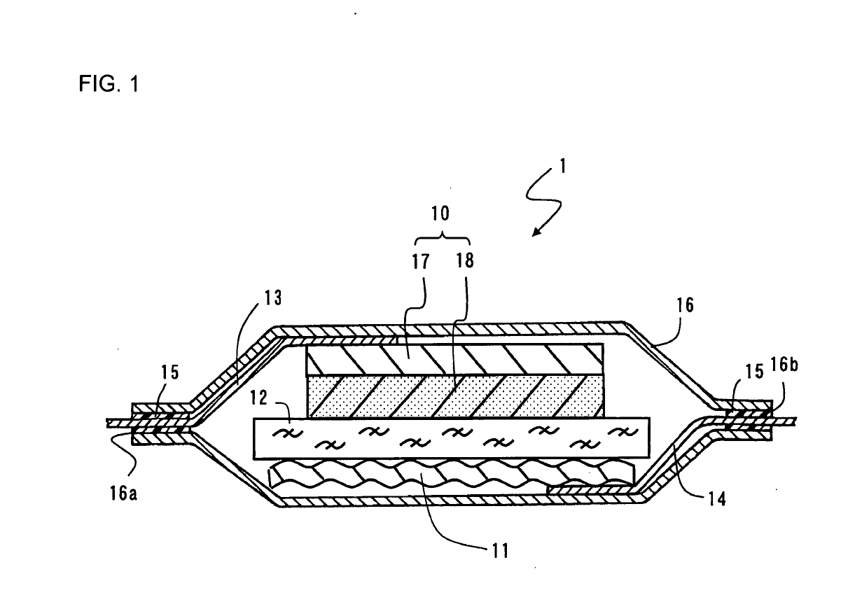

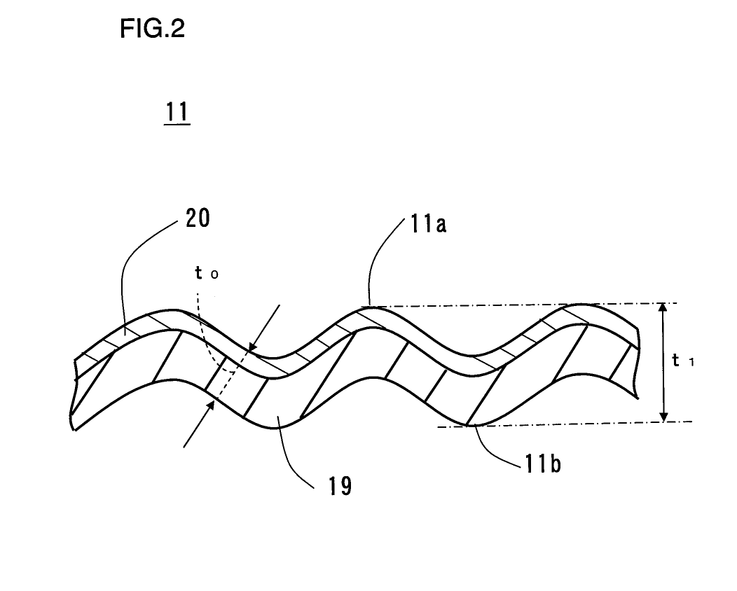

FIG. 1 is a schematic longitudinal sectional view of the structure of a lithium ion secondary battery 1 in one embodiment of the invention. FIG. 2 is an enlarged longitudinal sectional view of the structure of a negative electrode 11 included in the lithium ion secondary battery 1 illustrated in FIG. 1. The lithium ion secondary battery 1 includes a positive electrode 10, a negative electrode 11, a separator 12, a positive electrode lead 13, a negative electrode lead 14, gaskets 15, and a housing 16. The lithium ion secondary battery 1 is a layered-type battery including an electrode assembly that is formed by laminating the positive electrode 10, the separator 12, and the negative electrode 11.

The positive electrode 10 includes a positive electrode current collector 17 and a positive electrode active material layer 18.

The positive electrode current collector 17 can be one commonly used in this field, and examples include porous or non-porous conductive substrates. Examples of porous conductive substrates include mesh, net, punched sheets, lath, porous materials, foam, and sheets composed of fibers (e.g., non-woven fabric). Examples of non-porous conductive substrates include foil, sheets, and films. Examples of materials for conductive substrates include metal materials, such as stainless steel, titanium, aluminum, and aluminum alloy, and conductive resin. While the thickness of such a conductive substrate is not particularly limited, it is commonly 1 to 500 μm, preferably 1 to 50 μm, more preferably to 40 μm, and most preferably 10 to 30 μm.

The positive electrode active material layer 18 is provided on one face or both faces of the current collector in the thickness direction thereof, and contains a positive electrode active material. The positive electrode active material layer 18 may further contain a conductive agent, a binder, etc, in addition to the positive electrode active material.

The positive electrode active material can be a substance capable of absorbing and desorbing lithium ions, and examples include lithium-containing composite metal oxides and olivine-type lithium phosphates. A lithium-containing composite metal oxide is a metal oxide containing lithium and transition metal. Also, in a lithium-containing composite metal oxide, part of the transition metal may be replaced with one or more elements selected from Na, Mg, Sc, Y, Mn, Fe, Co, Zn, Al, Cr, Pb, Sb, and B. Among these elements, for example, Mn, Al, Co, Ni, and Mg are preferred.

Specific examples of lithium-containing composite metal oxides include LiₓCoO₂, LiₓNiO₂, LiₓMnO₂, LiₓCo_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄, LiMPO₄, and Li₂ MPO₄F where M is at least one element selected from the group consisting of Na, Mg, Sc, Y, Mn, Fe, Co, Ni, Cu, Zn, Al, Cr, Pb, Sb, and B, x=0 to 1.2, y=0 to 0.9, and z=2.0 to 2.3. It should be noted that the value x representing the molar ratio of lithium is a value immediately after the preparation of the positive electrode active material, and increases and decreases due to charge/discharge. Among them, lithium-containing composite metal oxides represented by the general formula LiₓCo_{y}M_{1-y}O_{z} where M, x, y, and z are the same as those described above are preferable.

These lithium-containing composite metal oxides can be prepared according to known methods. For example, a lithium-containing composite metal oxide can be obtained by preparing a composite metal hydroxide containing metal other than lithium by coprecipitation using an alkaline chemical such as sodium hydroxide, heat-treating the composite metal hydroxide to obtain a composite metal oxide, mixing it with a lithium compound such as lithium hydroxide, and heat-treating the resultant mixture.

A specific example of olivine-type lithium phosphates is, for example, LiQPO₄ where Q is at least one selected from the group consisting of Co, Ni, Mn, and Fe.

These positive electrode active materials can be used singly, or if necessary, in combination of two or more of them.

The conductive agent can be one commonly used in this field, and examples include graphites such as natural graphite and artificial graphite, carbon blacks such as acetylene black, ketjen black, channel black, furnace black, lamp black, and thermal black, conductive fibers such as carbon fiber and metal fiber, carbon fluoride, metal powders such as aluminum, conductive whiskers such as zinc oxide whiskers and conductive potassium titanate whiskers, conductive metal oxides such as titanium oxide, and organic conductive materials such as phenylene derivatives. These conductive agents can be used singly or in combination of two or more of them.

The binder can also be one commonly used in this field, and examples include polyvinylidene fluoride (PVDF), polytetrafluoroethylene, polyethylene, polypropylene, aramid resin, polyamide, polyimide, polyamide-imide, polyacrylonitrile, polyacrylic acid, polymethyl acrylates, polyethyl acrylates, polyhexyl acrylates, polymethacrylic acid, polymethyl methacrylates, polyethyl methacrylates, polyhexyl methacrylates, polyvinyl acetate, polyvinyl pyrrolidone, polyether, polyethersulfone, hexafluoropolypropylene, styrene butadiene rubber, modified acrylic rubber, and carboxymethyl cellulose.

Also, the binder can be a copolymer of two or more of monomer compounds. Examples of monomer compounds include tetrafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. These binders can be used singly or in combination of two or more of them.

The positive electrode active material layer 18 can be formed, for example, by applying a positive electrode mixture slurry onto a surface of the positive electrode current collector 17, drying it, and rolling it. The thickness of the positive electrode active material layer 18 can be selected as appropriate, depending on various conditions, but is preferably about 50 to 100 μm.

The positive electrode mixture slurry can be prepared by dissolving or dispersing a positive electrode active material and, if necessary, a conductive agent, a binder, etc. in an organic solvent. As the organic solvent, it is possible to use, for example, dimethylformamide, dimethyl acetamide, methyl formamide, N-methyl-2-pyrrolidone (NMP), dimethyl amine, acetone, and cyclohexanone.

Also, when the positive electrode mixture slurry contains a positive electrode active material, a conductive agent, and a binder, the ratio of these three components is not particularly limited. However, they should be preferably used so that the positive electrode active material accounts for 80 to 99% by weight of the total amount of these three components, the conductive agent accounts for 0.1 to 10% by weight, and the binder accounts for 0.1 to 10% by weight, with the total amount being 100% by weight.

The negative electrode 11 includes a negative electrode current collector 19 and a thin-film negative electrode active material layer 20, and is shaped like waves in a section in the thickness direction as illustrated in FIG. 1 and FIG. 2. More specifically, when the positive electrode 10, the separator 12, and the negative electrode 11 are laminated in this order, the sectional shape of the negative electrode 11 in the laminating direction or the sectional shape in the direction perpendicular to the laminating direction are wavy.

That is, unlike the flat plate shape in conventional art, the negative electrode 11 is in the shape of waves in a section in the thickness direction. Thus, the whole surface of the negative electrode active material layer 20 does not face the positive electrode active material layer 18 at an almost equal distance with the separator 12 interposed therebetween. However, the battery 1 has a sufficient high capacity and a high power because it uses the negative electrode active material layer 20 including an alloy-type negative electrode active material in which the ratio A/B of the volume A in a charged state to the volume B in a discharged state is 1.2 or more.

Also, when a trouble such as an internal short-circuit occurs and the separator 12 shrinks or melts, the wavy sectional shape decreases the contact area of the negative electrode active material layer 20 and the positive electrode active material layer 18, thereby permitting a reduction in the resistance between the active material layers.

It is thus possible to suppress the generation of heat due to an internal short-circuit etc. and prevent the battery 1 from significantly heating up to a high temperature. Also, the whole negative electrode 11 is deformed to a shape suitable for reducing the expansion stress of the alloy-type negative electrode active material. Hence, even if no space or gap is formed in the negative electrode active material layer 20, it is possible to fully prevent deformation of the negative electrode current collector 19 and thus the negative electrode 11.

The wave pitch in the section in the thickness direction is preferably 0.5 to 3 mm, and more preferably 1.0 to 2.5 mm. If the wave pitch is less than 0.5 mm, the stress exerted on the negative electrode current collector 19 is too large, which may result in cracking or breakage of the negative electrode current collector 19. If it exceeds 3 mm, in the event of an internal short-circuit, the contact area with the positive electrode active material layer 18 becomes large, and therefore, the heat generation due to the short-circuit may not be sufficiently reduced.

In the negative electrode 11, the ratio t1/t0 of the largest thickness t1 to the smallest thickness t0 is from 1.2 to 3.0, and preferably from 1.5 to 2.5. As used herein, the largest thickness t1 and the smallest thickness t0 refer to the largest thickness and the smallest thickness in a section in the thickness direction, respectively.

More specifically, as shown in FIG. 2, the largest thickness t1 refers to, in the negative electrode 11 placed on a horizontal plane, the vertical distance from an apex (highest point) 11a of the waveform protruding vertically upward and an apex (lowest point) 11b of the waveform protruding vertically downward.

Also, the smallest thickness to usually refers to the thickness of the flat negative electrode plate. In the invention, the negative electrode 11 is produced by preparing a flat negative electrode plate and then subjecting it to a corrugating process, as will be described later. The smallest thickness t0 is preferably 30 to 150 μm.

The effects obtained by selecting the ratio t1/t0 in the above-mentioned range are not limited to the increased resistance in the event of internal short-circuit and the reduced heat generation. Making the sectional shape wavy usually increases the distance between the positive and negative electrodes locally, which may have a significant adverse effect on the power and other characteristics of the battery.

However, in the invention, the use of an alloy-type negative electrode active material as the negative electrode active material and the selection of the ratio t1/t0 in the specific range allow the resistance between the positive and negative electrodes to be maintained at a level at which no practical problem occurs, thereby preventing the power characteristics of the lithium ion secondary battery 1 from lowering. If the ratio t1/t0 is less than 1.2, the amount of heat generated upon a short-circuit is not sufficiently reduced. Also, if the ratio t1/t0 exceeds 3.0, the high power characteristics lower.

In the invention, a negative electrode active material layer is formed on a flat current collector plate to prepare a negative electrode, and the negative electrode is then shaped into wavy form, as will be described later. Hence, a porous or non-porous conductive substrate can be used as the negative electrode current collector 19. Examples of porous conductive substrates include mesh, net, punched sheets, lath, porous materials, foam, and sheets composed of fibers (e.g., non-woven fabric). Examples of non-porous conductive substrates include foil, sheets, and films. Examples of materials for conductive substrates include metal materials, such as stainless steel, titanium, nickel, copper, and copper alloys, and conductive resin. While the thickness of such a conductive substrate is not particularly limited, it is commonly 1 to 500 μm, preferably 1 to 50 μm, more preferably 10 to 40 μm, and most preferably 10 to 30 μm.

The negative electrode active material layer 20 contains an alloy-type negative electrode active material as the main component. The ratio A/B of the volume A of the negative electrode active material layer 20 in a charged state to the volume B thereof in a discharged state is 1.2 or more. The negative electrode active material layer 20 is formed on one face or both faces of a conductive substrate in the thickness direction. As used herein, “discharged state” refers to the state in which the voltage of the battery 1 is 2.5 V.

Also, the negative electrode active material layer 20 may be composed of, for example, an alloy-type negative electrode active material and trace amounts of unavoidable impurities. Also, in addition to an alloy-type negative electrode active material, the negative electrode active material layer 20 may further contain a known negative electrode active material that is not an alloy-type negative electrode active material, an additive, etc., as long as its characteristics are not impaired. Further, the negative electrode active material layer 20 is preferably an amorphous or low-crystalline thin film.

The alloy-type negative electrode active material is not particularly limited as long as the volume ratio A/B of the negative electrode active material layer 20 can be set to 1.2 or more, and any known material can be used. Among them, for example, silicon-containing compounds and tin-containing compounds are preferred.

Examples of silicon-containing compounds include silicon, silicon oxides, silicon nitrides, silicon-containing alloys, silicon compounds, and solid solutions thereof. Examples of silicon oxides include silicon oxides represented by the composition formula: SiOₐ where 0.05<a<1.95. Examples of silicon nitrides include silicon nitrides represented by the composition formula: SiNb where 0<b<4/3. Examples of silicon-containing alloys include alloys of silicon and one or more elements selected from the group consisting of Fe, Co, Sb, Bi, Pb, Ni, Cu, Zn, Ge, In, Sn, and Ti.

Examples of silicon compounds include compounds in which part of silicon contained in silicon, a silicon oxide, silicon nitride, or silicon-containing alloy is replaced with one or more elements selected from the group consisting of B, Mg, Ni, Ti, Mo, Co, Ca, Cr, Cu, Fe, Mn, Nb, Ta, V, W, Zn, C, N, and Sn. Among these, silicon and silicon oxides are particularly preferred.

Examples of tin-containing compounds include tin, tin oxides, tin nitrides, tin-containing alloys, tin compounds, and solid solutions thereof. Preferable examples of tin-containing compounds include tin, tin oxides such as SnO_{d} where 0<d<2 and SnO₂, tin-containing alloys such as Ni—Sn alloy, Mg—Sn alloy, Fe—Sn alloy, Cu—Sn alloy, and Ti—Sn alloy, and tin compounds such as SnSiO₃, Ni₂Sn₄, and Mg₂Sn. Among them, tin and tin oxides such as SnO_{d} where 0<d<2 and SnO₂ are particularly preferable. These silicon-containing compounds and tin-containing compounds can be used singly or in combination of two or more of them.

The negative electrode active material layer 20 can be formed on a surface of a conductive substrate by a known thin film formation method such as sputtering, deposition, or chemical vapor deposition (CVD). After the production of the negative electrode 11 that is in the shape of a flat plate and not subjected to a corrugating process, the negative electrode active material layer 20 may be supplemented with lithium corresponding to the irreversible capacity in the initial charge/discharge

The negative electrode 11 can be formed, for example, by utilizing the stress due to expansion and contraction of the alloy-type negative electrode active material during charge/discharge. Specifically, by properly selecting the expansion rate of the alloy-type negative electrode active material, the thickness and porosity of the negative electrode active material layer, the mechanical strength of the conductive substrate, etc., the flat negative electrode plate can be deformed so that the sectional shape in the thickness direction becomes wavy. That is, by selecting the above conditions in forming a negative electrode, mounting the negative electrode in a battery, and charging/discharging the battery, the flat negative electrode plate deforms to the negative electrode 11 having a wavy sectional shape.

For example, in the case of using an alloy-type negative electrode active material with an expansion rate of approximately 1.4 to 1.6, the thickness of the negative electrode active material layer is set in the range of 20 to 30 μm, the porosity of the negative electrode active material layer 20 is set to 40 to 50%, and a metal foil with a thickness of 30 to 40 μm which deforms by a stress of 5 to 7 N/mm per unit width is used as the conductive substrate. In this case, the negative electrode 11 with a t1/t0 ratio of 1.5 to 2.5 and a wave pitch of 0.7 to 2.5 mm is obtained.

In the case of forming the negative electrode active material layer 20 by deposition, the porosity of the negative electrode active material layer 20 can be adjusted, for example, by selecting the incident angle of the vapor of the alloy-type negative electrode active material from the evaporation source relative to the surface of the conductive substrate.

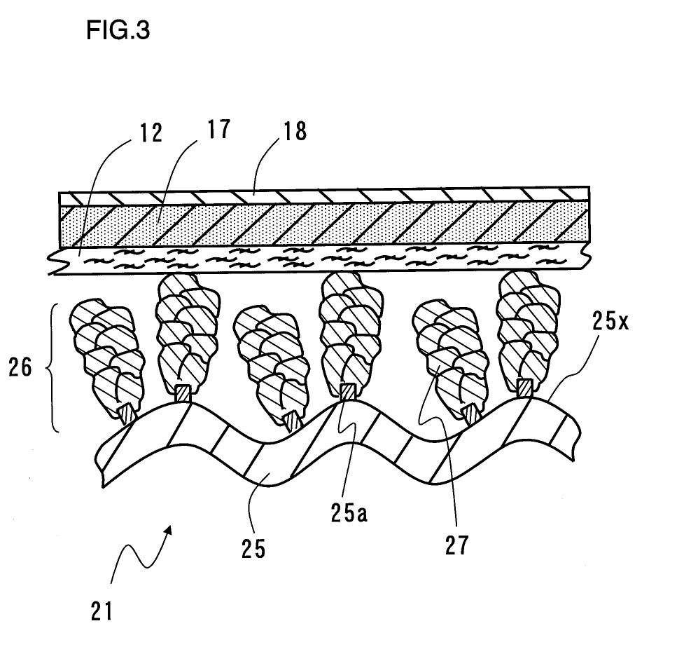

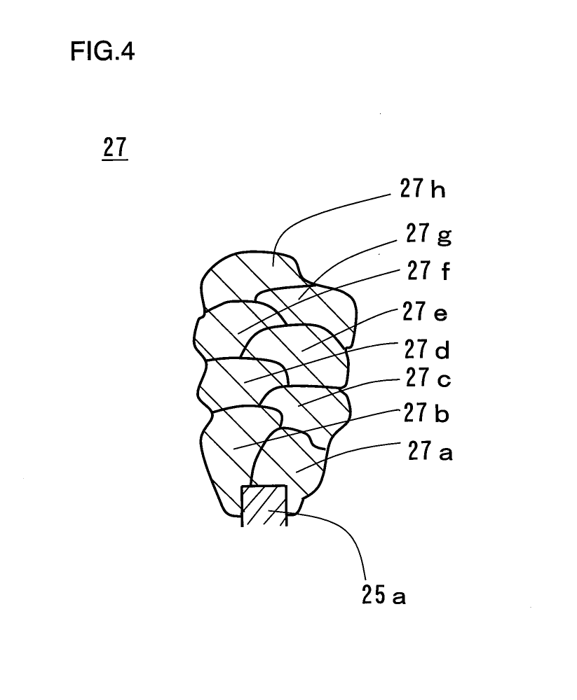

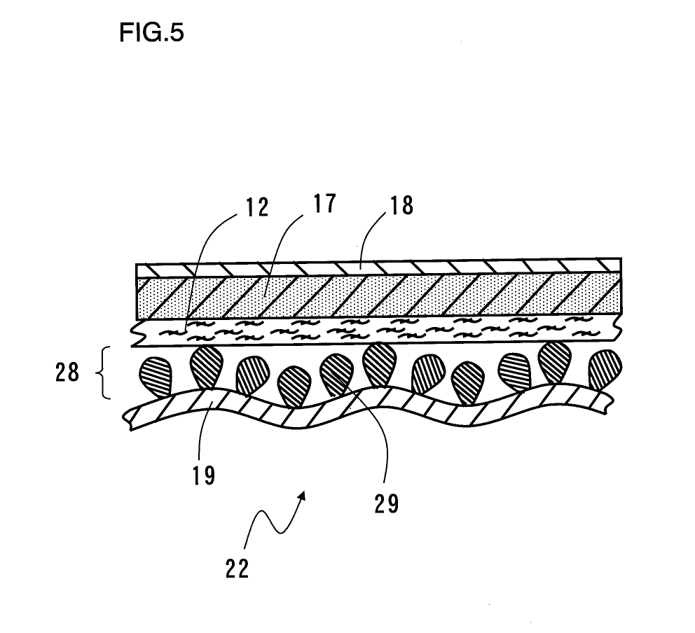

In the lithium ion secondary battery 1, a negative electrode 21 as illustrated in FIG. 3 or a negative electrode 22 as illustrated in FIG. 5 may also be used instead of the negative electrode 11. FIG. 3 is a schematic longitudinal sectional view of the structure of the negative electrode 21 in another embodiment. FIG. 4 is an enlarged longitudinal sectional view of the structure of a column 27 included in the negative electrode 21 of FIG. 3. FIG. 5 is a schematic longitudinal sectional view of the structure of the negative electrode 22 in another embodiment.

The negative electrode 21 includes a negative electrode current collector 25 and a negative electrode active material layer 26, and the ratio t1/t0 is from 1.2 to 3.0, and preferably from 1.5 to 2.5. Although the negative electrode current collector 25 is similar to the negative electrode current collector 19, it is characterized in that protrusions 25a are formed on one surface in the thickness direction. The protrusions 25a will be described later. Also, the negative electrode active material layer 26 includes a plurality of columns 27 which form a thin-film negative electrode active material layer as a whole. The columns 27 extend outwardly from the surfaces of the protrusions 25a.

The protrusions 25a protrude outwardly from a surface 25x of the negative electrode current collector 25 in the thickness direction. The height of each of the protrusions 25a is, in the direction perpendicular to the surface 25x of the negative electrode current collector 25, the length from the surface 25x to the furthest part (outermost part) of the protrusion 25a from the surface 25x. While the height of the protrusions 25a is not particularly limited, the average height is preferably about 3 to 10 μm. Also, while the sectional diameter of the protrusions 25a in the direction parallel to the surface 25x is not particularly limited either, it is, for example, 1 to 50 μm.

The average height of the protrusions 25a can be determined, for example, by observing a section of the negative electrode current collector 25 in the thickness direction with a scanning electron microscope (SEM), measuring the heights of, for example, 100 protrusions 25a, and calculating the average value from the measured values. The sectional diameter of the protrusions 25a can be determined in the same manner as the height of the protrusions 25a. It should be noted that all the protrusions 25a do not have the same height or same sectional diameter.

Each of the protrusions 25a has an almost flat top face at the end in the grow direction. As used herein, the grow direction refers to the direction from the surface of the negative electrode current collector 25 toward the outside. When the end of the protrusion 25a is a flat top face, the adhesion between the protrusion 25a and the column 27 is enhanced. In terms of enhancing the bonding strength, it is more preferable that the flat face at the end be almost parallel to the surface 25x.

The shape of the protrusions 25a is a circle. As used herein, the shape of the protrusions 25a refers to the shape of the protrusions 25 viewed vertically from above when the negative electrode current collector 25 is placed in such a manner that the face opposite the surface 25x is in contact with a horizontal plane. The shape of the protrusions 25a is not limited to a circle and may be, for example, a polygon or an oval. In consideration of production costs, etc., the polygon is preferably a triangle to an octagon, and more preferably an equilateral triangle to an equilateral octagon. Further, it may be a parallelogram, a trapezoid, or a rhombus.

The number of the protrusions 25a, the interval between the protrusions 25a, and the like are not particularly limited and can be selected as appropriate, depending on, for example, the size (e.g., height and sectional diameter) of the protrusions 25a and the size of the columns 27 formed on the surfaces of the protrusions 25a. The number of the protrusions 25a is, for example, approximately 10,000/cm² to 10,000,000/cm². Also, the protrusions 25a are preferably formed so that the axis-to-axis distance of the adjacent protrusions 25a is approximately 2 to 100 μm.

The surface of the protrusion 25a may be provided with a bump (not shown). In this case, for example, the adhesion between the protrusion 25a and the column 27 is further enhanced, so that separation etc. of the protrusion 25a from the column 27 is prevented in a more reliable manner. The bump is provided so as to extend outwardly from the surface of the protrusion 25a. Two or more bumps smaller than the protrusion 25a may be provided.

Also, the bump may be formed on a side face of the protrusion 25a so as to extend in the circumferential direction and/or grow direction of the protrusion 25a. Also, when the protrusion 25a has a flat top face at the end, the top face may have one or more bumps smaller than the protrusion 25a. Further, the top face may have one or more bumps that extend a long distance in one direction.

The negative electrode current collector 21 can also be formed, for example, by forming a resist pattern on the conductive substrate by the photoresist method, and applying a metal plating according to the pattern.

The negative electrode active material layer 26 is an aggregate of the columns 27 extending in the same direction, and the volume ratio A/B thereof is 1.2 or more. The columns 27 contain an alloy-type negative electrode active material, preferably a silicon-containing compound or tin-containing compound. The adjacent columns 27 are spaced apart and extend in the same direction. Thus, the negative electrode active material layer 26 is a thin film as a whole.

It should be noted that in FIG. 3, the columns 27 are not illustrated as extending in the same direction. This is for the following reason. A flat negative electrode plate is prepared by forming the columns 27 that extend in the same direction on a surface of a conductive substrate, and this flat negative electrode plate is subjected to a corrugating process to make the whole negative electrode wavy in the same manner as the negative electrode 11.

The columns 27 are provided so as to extend in the direction perpendicular to the surface of the conductive substrate, or so as to extend slantwise relative to the direction perpendicular thereto. Also, since the adjacent columns 27 are spaced apart from one another, the stress due to expansion and contraction during charge/discharge is reduced. Thus, separation of the columns 27 from the negative electrode current collector 25, further deformation of the negative electrode current collector 25 and the negative electrode 21, etc., are unlikely to occur.

As illustrated in FIG. 4, the column 27 is more preferably provided in the form of a columnar structure consisting of a laminate of eight columnar particles 27a, 27b, 27c, 27d, 27e, 27f, 27g, and 27h. In forming the column 27, first, the columnar particle 27a is formed so as to cover at least a part of the top face of the protrusion 25a and a part of the side face. Next, the columnar particle 27b is formed so as to cover the remaining part of the top face of the protrusion 25a and a part of the top face of the columnar particle 27a. The columnar particle 27c is formed so as to cover the remaining part of the top face of the columnar particle 27a and a part of the top face of the columnar particle 27b. Further, the columnar particle 27d is formed so that it mainly contacts the columnar particle 27b. Likewise, the columnar particles 27e, 27f, 27g, and 27h are alternately laminated to form the column 27.

In this embodiment, eight columnar particles are laminated, but this is not construed as limiting, and two or more columnar particles may be laminated.

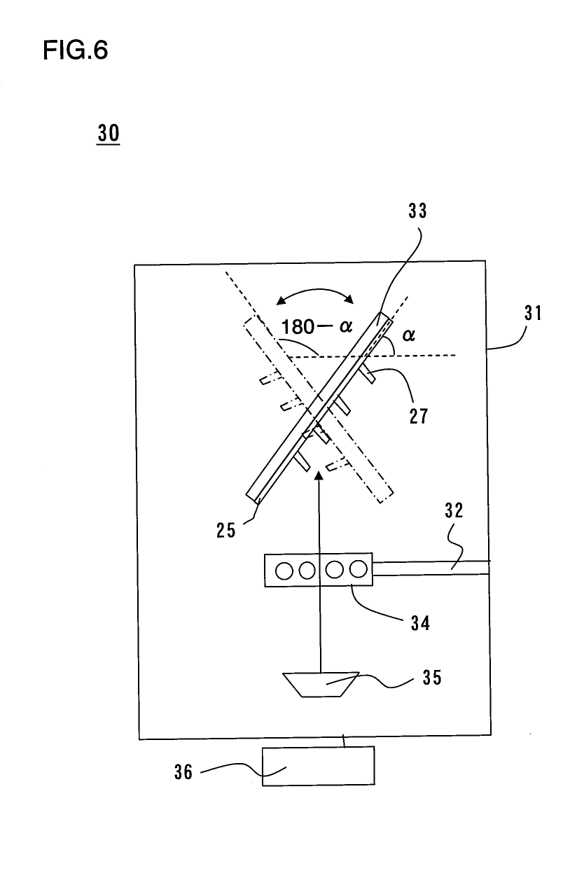

The negative electrode active material layer 26 can be produced using, for example, an electron beam deposition device 30 illustrated in FIG. 6. FIG. 6 is a schematic side view of the structure of the electron beam deposition device 30. In FIG. 6, the respective components in the deposition device 30 are also illustrated by the solid line. The deposition device 30 includes a chamber 31, a first pipe 32, a fixing bench 33, a nozzle 34, a target 35, an electron beam generator (not shown), a power source 36, and a second pipe (not shown).

The chamber 31 is a pressure-resistant container having an inner space. In the inner space are the first pipe 32, the fixing bench 33, the nozzle 34, and the target 35. One end of the first pipe 32 is connected to the nozzle 34, and the other end is connected via a massflow controller (not shown) to a raw material gas cylinder or raw material gas production device (not shown) placed outside the chamber 31. Examples of raw material gases include oxygen and nitrogen. A raw material gas is supplied to the nozzle 34 through the first pipe 32.

The fixing bench 33 is shaped like a plate and is rotatably supported. The negative electrode current collector 25 is to be fixed to one face of the fixing bench 33 in the thickness direction. In FIG. 6, the protrusions formed on the surface of the conductive substrate are not illustrated. The fixing bench 33 is rotated between the position shown by the solid line and the position shown by the alternate long and short dashed lines in FIG. 6.

When the fixing bench 33 is at the position shown by the solid line, the face of the fixing bench 33 to which the negative electrode current collector 25 is to be fixed faces the nozzle 34 positioned vertically below the fixing bench 33, and the angle formed between the fixing bench 33 and a straight line in the horizontal direction is a°. When the fixing bench 33 is at the position shown by the alternate long and short dashed lines, the face of the fixing bench 33 to which the negative electrode current collector 25 is to be fixed faces the nozzle 34 positioned vertically below the fixing bench 33, and the angle formed between the fixing bench 33 and a straight line in the horizontal direction is (180−a)°. The angle α° is the incident angle of the vapor, and by appropriately selecting the angle α°, it is possible to change, for example, the porosity of the negative electrode active material layer 26, the slanting angle of the columns 27 relative to the surface of the negative electrode current collector 25, and the dimensions of the columns 27.

The nozzle 34 is disposed vertically between the fixing bench 33 and the target 35 and connected to one end of the first pipe 32. Through the nozzle 34, a mixture of the vapor of an alloy-type negative electrode active material rising vertically from the target 35 and the raw material gas supplied from the first pipe 32 is fed to the surface of the negative electrode current collector 25 fixed to the surface of the fixing bench 33.

The target 35 contains the alloy-type negative electrode active material or the raw material thereof. The alloy-type negative electrode active material or the raw material thereof contained in the target 35 is illuminated with an electron beam by the electron beam generator, so that it is heated and becomes vapor.

The power source 36, which is disposed outside the chamber 31, is electrically connected to the electron beam generator for applying a voltage necessary for generating an electron beam to the electron beam generator. The second pipe is used to fill the chamber 31 with a gas. An electron beam deposition device with the same structure as that of the deposition device 30 is commercially available, for example, from ULVAC, Inc.

The electron beam deposition device 30 is operated as follows. First, negative electrode current collector 25 with protrusions formed on a surface is fixed to the fixing bench 33, and oxygen gas is introduced into the chamber 31. In this state, the alloy-type negative electrode active material or the raw material thereof in the target 35 is illuminated with an electron beam so that it is heated and becomes vapor. The vapor rises vertically, and when it passes through the nozzle 34, it is mixed with the raw material gas. The vapor further rises and is fed to the surface of the negative electrode current collector 25 fixed to the fixing bench 33, so that a layer containing the alloy-type negative electrode active material and the raw material gas is formed on each of the tops of the protrusions and a part of the vicinity thereof.

At this time, by placing the fixing bench 33 at the position shown by the solid line, the columnar particle 27a illustrated in FIG. 4 is formed. Next, by rotating the fixing bench 33 to the position shown by the alternate long and short dashed lines, the columnar particle 27b illustrated in FIG. 4 is formed. In this way, by alternately rotating the fixing bench 33, the columns 27 each of which is a laminate of the eight columnar particles 27a, 27b, 27c, 27d, 27e, 27f, 27g, and 27h illustrated in FIG. 4 are grown, so that the negative electrode active material layer 26 is formed.

When the alloy-type negative electrode active material is, for example, a silicon oxide represented by SiOₐ where 0.05<a<1.95, the columns 27 may be formed so that there is an oxygen concentration gradient in the thickness direction of the columns 27. Specifically, the columns 27 may be formed so that the oxygen content is high near the negative electrode current collector 25 and that the oxygen content lowers as the distance from the negative electrode current collector 25 increases. In this case, the adhesion between the negative electrode current collector 25 and the column 27 can be further enhanced.

It should be noted that when no raw material gas is supplied from the nozzle 34, the columns 27 formed are composed mainly of the alloy-type negative electrode active material in the form of a simple substance.

The negative electrode 22 illustrated in FIG. 5 includes a negative electrode current collector 19 and a negative electrode active material layer 28, and the ratio t1/t0 is 1.2 to 3.0, and preferably 1.5 to 2.5. The negative electrode active material layer 28 includes a plurality of spindle-shaped columns 29 containing an alloy-type negative electrode active material, and the volume ratio A/B is 1.2 or more. The spindle-shaped columns 29 can be produced in the same manner as the columns 27.

In the negative electrode 22, also, the spindle-shaped columns 29 extending in the same direction are formed on a surface of a conductive substrate, and the resultant substrate is subjected to a corrugating process in the same manner as the negative electrode 11. Thus, when for example, an internal short-circuit occurs and the separator 12 melts or contracts, the contact area of the positive electrode active material layer 17 and the negative electrode active material layer 28 can be reduced.

Referring back to FIG. 1, the separator 12 is disposed between the positive electrode 10 and the negative electrode 11. The separator 12 is a sheet or film with predetermined ion permeability, mechanical strength, insulating property, etc. Specific examples of the separator 12 include porous sheets and films such as microporous films, woven fabric, and non-woven fabric. The microporous film may be a monolaminar film or a multi-laminar film (composite film). The monolaminar film is composed of one kind of material. The multi-laminar film (composite film) is a laminate of monolaminar films composed of the same material or a laminate of monolaminar films composed of different materials.

Various resin materials can be used as the material of the separator 12, but in consideration of durability, shut-down function, battery safety, etc., polyolefins such as polyethylene and polypropylene are preferred. The shut-down function as used herein refers to the function of a separator the through-holes of which are closed when the battery abnormally heats up, thereby suppressing the permeation of ions and shutting down the battery reaction. If necessary, the separator 12 may be composed of a laminate of two or more layers such as a microporous film, woven fabric, and non-woven fabric.

The thickness of the separator 12 is typically 10 to 300 μm, but it is preferably 10 to 40 μm, more preferably 10 to 30 μm, and most preferably 10 to 25 μm. Also, the porosity of the separator 12 is preferably 30 to 70%, and more preferably 35 to 60%. The porosity as used herein refers to the ratio of the total volume of the pores in the separator 12 to the volume of the separator 12.

The separator 12 is impregnated with a lithium-ion conductive electrolyte. The lithium-ion conductive electrolyte is preferably a lithium-ion conductive non-aqueous electrolyte. Examples of non-aqueous electrolytes include liquid non-aqueous electrolytes, gelled non-aqueous electrolytes, and solid electrolytes (e.g., polymer solid electrolytes).

A liquid non-aqueous electrolyte contains a solute (supporting salt), a non-aqueous solvent, and optionally various additives. The solute is usually dissolved in the non-aqueous solvent. The liquid non-aqueous electrolyte is impregnated, for example, into the separator.

The solute can be one commonly used in this field, and examples include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylates, LiCl, LiBr, LiI, LiBCl₄, borates, and imide salts.

Examples of borates include lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate.

Examples of imide salts include lithium bistrifluoromethanesulfonyl imide ((CF₃SO₂)₂NLi), lithium trifluoromethanesulfonyl nonafluorobutanesulfonyl imide ((CF₃SO₂) (C₄F₉SO₂)NLi), and lithium bispentafluoroethanesulfonyl imide ((C₂F₅SO₂)₂NLi). These solutes can be used singly or in combination of two or more of them. The amount of the solute dissolved in the non-aqueous solvent is desirably in the range of 0.5 to 2 mol/L.

The non-aqueous solvent can be one commonly used in this field, and examples include cyclic carbonic acid esters, chain carbonic acid esters, and cyclic carboxylic acid esters. Examples of cyclic carbonic acid esters include propylene carbonate (PC) and ethylene carbonate (EC). Examples of chain carbonic acid esters include diethyl carbonate (DEC), ethyl methyl carbonate (EMC), and dimethyl carbonate (DMC). Examples of cyclic carboxylic acid esters include γ-butyrolactone (GBL) and γ-valerolactone (GVL). These non-aqueous solvents can be used singly or in combination of two or more of them.

Examples of additives include materials that improve coulombic efficiency and materials that deactivate a battery. For example, a material that improves coulombic efficiency decomposes on the negative electrode to form a coating film of high lithium-ion conductivity, thereby enhancing coulombic efficiency. Specific examples of such materials include vinylene carbonate (VC), 4-methyl vinylene carbonate, 4,5-dimethyl vinylene carbonate, 4-ethyl vinylene carbonate, 4,5-diethyl vinylene carbonate, 4-propyl vinylene carbonate, 4,5-dipropyl vinylene carbonate, 4-phenyl vinylene carbonate, 4,5-diphenyl vinylene carbonate, vinyl ethylene carbonate (VEC), and divinyl ethylene carbonate. They can be used singly or in combination of two or more of them. Among them, at least one selected from vinylene carbonate, vinyl ethylene carbonate, and divinyl ethylene carbonate is preferable. In these compounds, a part of the hydrogen atoms contained may be replaced with fluorine atom(s).

For example, a material that deactivates a battery decomposes upon battery overcharge to form a coating film on the electrode surface, thereby deactivating the battery. Examples of such materials include benzene derivatives. Examples of benzene derivatives include benzene compounds containing a phenyl group and a cyclic compound group adjacent to the phenyl group. Preferable examples of cyclic compound groups include phenyl groups, cyclic ether groups, cyclic ester groups, cycloalkyl groups, and phenoxy groups. Specific examples of benzene derivatives include cyclohexyl benzene, biphenyl, and diphenyl ether. These benzene derivatives can be used singly or in combination of two or more of them. However, the content of the benzene derivative in the liquid non-aqueous electrolyte is preferably equal to or less than 10 parts by volume per 100 parts by volume of the non-aqueous solvent.

A gelled non-aqueous electrolyte includes a liquid non-aqueous electrolyte and a polymer material that retains the liquid non-aqueous electrolyte. The polymer material as used herein is a material capable of gelling a liquid. The polymer material can be one commonly used in this field, and examples include polyvinylidene fluoride, polyacrylonitrile, polyethylene oxide, polyvinyl chloride, and polyacrylate.

A solid electrolyte includes, for example, a solute (supporting salt) and a polymer material. The solute can be the same material as that described above. Examples of polymer materials include polyethylene oxide (PEO), polypropylene oxide (PPO), and a copolymer of ethylene oxide and propylene oxide.

One end of the positive electrode lead 13 is connected to the positive electrode current collector 17, and the other end is drawn to the outside of the lithium ion secondary battery 1 through an opening 16a of the housing 16. One end of the negative electrode lead 14 is connected to the negative electrode current collector 19, and the other end is drawn to the outside of the lithium ion secondary battery 1 through an opening 16b of the housing 16. The positive electrode lead 13 and the negative electrode lead 14 can be any material commonly used in the technical field of lithium ion secondary batteries.

Also, the openings 16a and 16b of the housing 16 are sealed with the gaskets 15. For the gasket 15, for example, various resin materials can be used. The housing 16 can also be any material commonly used in the technical field of lithium ion secondary batteries. The openings 16a and 16b of the housing 16 can be directly sealed by welding or the like, without using the gaskets 15.

The lithium ion secondary battery 1 can be produced, for example, as follows. First, one end of the positive electrode lead 13 is connected to the face of the positive electrode current collector 17 opposite the face on which the positive electrode active material layer 18 is formed. Likewise, one end of the negative electrode lead 14 is connected to the face of the negative electrode current collector 19 opposite the face on which the thin-film negative electrode active material layer 20 is formed.

Next, the positive electrode 10 and the negative electrode 12 are laminated with the separator 12 interposed therebetween, to form an electrode assembly. At this time, the positive electrode 10 and the negative electrode 11 are disposed so that the positive electrode active material layer and the negative electrode active material layer 20 face each other. This electrode assembly is inserted, with the electrolyte, into the housing 16, and the other end of the positive electrode lead 13 and the other end of the negative electrode lead 14 are drawn to the outside of the housing 16.

In this state, while the housing 16 is being evacuated, the openings 16a and 16b are welded with the gaskets 15, to produce the lithium ion secondary battery 1.

FIG. 1 illustrates an example of a layered-type lithium ion secondary battery, but this is not construed as limiting the invention; the invention is applicable to a wound-type battery produced by laminating a positive electrode, a separator, a negative electrode, and a separator in this order, winding the laminate to form an electrode assembly, and placing the electrode assembly into a housing or battery can.

The lithium ion secondary battery of the invention can be used in the same applications as conventional lithium ion secondary batteries, and in particular, is useful as the power source for portable electronic devices such as personal computers, cellular phones, mobile devices, portable digital assistants (PDAs), portable game machines, and video cameras. Also, the lithium ion secondary battery of the invention is expected to be used, for example, as the secondary battery for assisting the electric motor of hybrid electric vehicles and fuel cell cars, the power source for driving power tools, vacuum cleaners, and robots, and the power source for plug-in HEVs.

The invention is hereinafter described specifically by way of Examples and Comparative Examples.

### EXAMPLE 1

### (1) Preparation of Positive Electrode

A positive electrode mixture paste was prepared by sufficiently mixing 10g of lithium cobaltate (LiCoO₂), 0.3 g of acetylene black (conductive agent), 0.8 g of polyvinylidene fluoride powder (binder), and 5 ml of N-methyl-2-pyrrolidone (NMP). This positive electrode mixture paste was applied onto one face of a 20-μm thick aluminum foil (positive electrode current collector), dried, and rolled to form a positive electrode active material layer. This was then cut into a square of 30 mm×30 mm, to obtain a positive electrode.

In the positive electrode thus obtained, the positive electrode active material layer carried on one face of the aluminum foil had a thickness of 70 μm and a size of 30 mm×30 mm. An aluminum positive electrode lead was connected to the face of the aluminum foil opposite the face on which the positive electrode active material layer was formed.

### (2) Preparation of Negative Electrode

A rolled copper foil (thickness 30 μm, dimensions 40 mm×40 mm, available from Nippon Foil Mfg. Co., Ltd.) having protrusions (height: approximately 5 μm, width (diameter): 4 μm, shape: circular) on a surface at an interval of 10 μm was used as the negative electrode current collector. Using a commercially available deposition device (available from ULVAC, Inc.) having the same structure as that of the electron beam deposition device 30 illustrated in FIG. 6, a negative electrode active material layer was formed as an aggregate of columns formed on the protrusions 25a on the surface of the negative electrode current collector 25.

The angle α between the fixing bench to which the 40 mm×40 mm negative electrode current collector was fixed and a straight line in the horizontal direction was set to 60°. In this way, a negative electrode active material layer composed of a plurality of monolaminar columns was formed. These columns were grown slantwise relative to the direction perpendicular to the surface of the negative electrode current collector 25. The deposition conditions were as follows.

Raw material of negative electrode active material (evaporation source): silicon, purity 99.9999%, available from Kojundo Chemical Lab. Co., Ltd

Oxygen released from nozzle: purity 99.7%, available from Nippon Sanso Corporation

Flow rate of oxygen from nozzle: 25 sccm

Acceleration voltage of electron beam: −8 kV

Emission: 500 mA

Deposition time: 40 minutes

The thickness of the negative electrode active material layer thus formed was 20 μm, and the volume ratio A/B was 1.6 or more. The thickness of the negative electrode active material layer can be obtained by observing a cross-section of the negative electrode in the thickness direction thereof with a scanning electron microscope, selecting 10 columns formed on the surfaces of the protrusions, measuring the length from the top of the protrusion to the top of the column, and averaging the 10 measured values. Also, the amount of oxygen contained in the negative electrode active material layer was quantified by a combustion method, and the result showed that the composition of the compound constituting the negative electrode active material layer was SiO_{0.7}.

Next, lithium metal was deposited on the surface of the negative electrode active material layer. By depositing the lithium metal, the negative electrode active material layer was supplemented with lithium corresponding to the irreversible capacity in the initial charge/discharge. The deposition of lithium metal was performed under an argon atmosphere, using a resistance heating deposition device (available from ULVAC, Inc.). A tantalum boat in the resistance heating deposition device was charged with lithium metal, and the negative electrode was fixed so that the negative electrode active material layer faced the tantalum boat. While the tantalum boat was supplied with a current of 50 A, deposition was performed in an argon atmosphere for 10 minutes. In this way, a negative electrode (not subjected to a corrugating process) was produced. The current collector of this negative electrode was connected with one end of a nickel negative electrode lead.

### (3) Production of Cylindrical Battery

An electrode assembly was produced by laminating the positive electrode plate, a polyethylene microporous film (separator, trade name: Hipore, thickness 20 μm, available from Asahi Kasei Corporation), and the negative electrode plate in such a manner that the positive electrode active material layer and the thin-film negative electrode active material layer faced each other with the polyethylene microporous film interposed therebetween. This electrode assembly was inserted, with an electrolyte, into a housing made of an aluminum laminate sheet.

The electrolyte used was a non-aqueous electrolyte prepared by dissolving LiPF₆ at a concentration of 1.0 mol/L in a solvent mixture of ethylene carbonate (EC) and ethyl methyl carbonate (EMC) in a volume ratio of 1:1.

Next, the positive electrode lead and the negative electrode lead were drawn to the outside of the housing through the openings of the housing. While the housing was being evacuated, the openings of the housing were welded. In this way, a lithium ion secondary battery of the invention was produced.

### EXAMPLE 2

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 29 sccm, the angle α to 56°, and the deposition time to 35 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery of the invention was produced in the same manner as in Example 1 except for the use of this negative electrode.

### EXAMPLE 3

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 32 sccm, the angle α to 530, and the deposition time to 31 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery of the invention was produced in the same manner as in Example 1 except for the use of this negative electrode.

### EXAMPLE 4

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 36 sccm, the angle α to 500, and the deposition time to 28 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery of the invention was produced in the same manner as in Example 1 except for the use of this negative electrode.

### EXAMPLE 5

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 39 sccm, the angle α to 480, and the deposition time to 26 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery of the invention was produced in the same manner as in Example 1 except for the use of this negative electrode.

### EXAMPLE 6

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 43 sccm, the angle α to 45°, and the deposition time to 23 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery of the invention was produced in the same manner as in Example 1 except for the use of this negative electrode.

### EXAMPLE 7

A lithium ion secondary battery of the invention was produced in the same manner as in Example 1, except that the production method of the negative electrode was changed as follows.

### (Preparation of Negative Electrode)

A thin-film negative electrode active material layer was formed on one face of a negative electrode current collector in the thickness direction thereof which was produced in the same manner as in Example 1. The negative electrode active material layer was formed on the protrusions on the surface of the negative electrode current collector, using a commercially available deposition device (available from ULVAC, Inc.) having the same structure as that of the electron beam deposition device 30 illustrated in FIG. 6. The deposition conditions are as follows.

The fixing bench to which the 40 mm×40 mm negative electrode current collector was fixed was set so as to alternately rotate between the position at which the angle α=55° (the position shown by the solid line in FIG. 6) and the position at which the angle (180−α)=125° (the position shown by the alternate long and short dashed lines in FIG. 6). The negative electrode active material layer thus formed was composed of columns each of which is a zig-zag laminate of eight columnar particles as illustrated in FIG. 4.

Raw material of negative electrode active material (evaporation source): silicon, purity 99.9999%, available from Kojundo Chemical Lab. Co., Ltd

Oxygen released from nozzle: purity 99.7%, available from Nippon Sanso Corporation

Flow rate of oxygen from nozzle: 80 sccm

Angle α: 55°

Acceleration voltage of electron beam: −8 kV

Emission: 500 mA

Deposition time: 55 minutes

The thickness of the negative electrode active material layer thus formed was 20 μm, and the volume ratio A/B was 1.6 or more. The thickness of the negative electrode active material layer can be obtained by observing a cross-section of the negative electrode in the thickness direction thereof with a scanning electron microscope, selecting 10 column formed on the surfaces of the protrusions, measuring the length from the top of the protrusion to the top of the column, and averaging the 10 measured values. Also, the amount of oxygen contained in the negative electrode active material layer was quantified by a combustion method, and the result showed that the composition of the compound constituting the negative electrode active material layer was SiO_{0.7}.

Next, lithium metal was deposited on the surface of the negative electrode active material layer. By depositing the lithium metal, the negative electrode active material layer was supplemented with lithium corresponding to the irreversible capacity in the initial charge/discharge. The deposition of lithium metal was performed under an argon atmosphere, using a resistance heating deposition device (available from ULVAC, Inc.). A tantalum boat in the resistance heating deposition device was charged with lithium metal, and the negative electrode was fixed so that the negative electrode active material layer faced the tantalum boat. While the tantalum boat was supplied with a current of 50 A, deposition was performed in an argon atmosphere for 10 minutes. In this way, a negative electrode (not subjected to a corrugating process) was produced. A lithium ion secondary battery of the invention was produced in the same manner as in Example 1 except for the use of this negative electrode.

### EXAMPLE 8

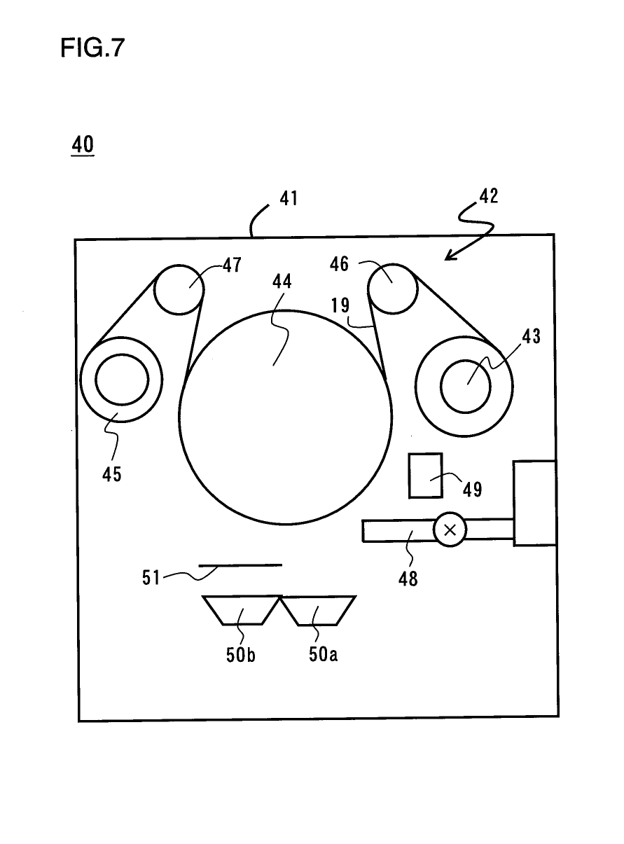

Using a deposition device 40, a thin-film negative electrode active material layer (silicon thin film) with a thickness of 6 μm and a volume ratio A/B of 1.6 or more was formed on a surface of a negative electrode current collector under the following conditions. FIG. 7 is a schematic side view of the structure of the deposition device 40. The deposition device 40 includes a vacuum chamber 41, a current-collector transporting means 42, a raw-material-gas supply means 48, a plasma-generating means 49, silicon targets 50a and 50b, a shielding plate 51, and an electron beam heating means (not shown).

The vacuum chamber 41 is a pressure-resistant container having an inner space whose pressure can be reduced. In the inner space are the current-collector transporting means 42, the raw-material-gas supply means 48, the plasma-generating means 49, the silicon targets 50a and 50b, the shielding plate 51, and the electron beam heating means.

The current-collector transporting means 42 includes an unwinding roller 43, a can 44, a rewinding roller 45, and transporting rollers 46 and 47. Each of the unwinding roller 43, the can 44, and the transporting rollers 46 and 47 is rotatably supported on the axis.

A long negative electrode current collector 19 is wound around the unwinding roller 43. The can 44 is larger in diameter than the other rollers, and contains a cooling means (not shown) therein. When the negative electrode current collector 19 is transported on the surface of the can 44, the negative electrode current collector 19 is also cooled. Thus, the vapor of an alloy-type negative electrode active material is cooled and deposited to form a thin film.

The rewinding roller 45 is rotatably supported on the axis by a driving means (not shown). One end of the negative electrode current collector 19 is fixed to the rewinding roller 45. Due to the rotation of the rewinding roller 45, the negative electrode current collector 19 is transported from the unwinding roller 43 through the transporting roller 46, the can 44, and the transporting roller 47. The negative electrode current collector 19 with a thin film of the alloy-type negative electrode active material formed on the surface is rewound around the rewinding roller 45.

In the case of forming a thin film composed mainly of an oxide, nitride, etc. of silicon or tin, the raw-material-gas supply means 48 supplies a raw material gas such as oxygen or nitrogen into the vacuum chamber 41. The plasma generating means 49 makes the raw material gas supplied from the raw-material-gas supply means 48 into plasmatic condition. The silicon targets 50a and 50b are used to form a thin film containing silicon.

The shielding plate 51 is horizontally movable vertically below the can 43 and vertically above the silicon targets 50a and 50b. The position of the shielding plate 51 in the horizontal direction is suitably adjusted depending on the condition of the thin film that is being formed on the surface of the negative electrode current collector 19. The electron beam heating means irradiates the silicon target 50a, 50b with an electron beam to heat it and produce a silicon vapor. The deposition conditions are as follows.

Pressure inside vacuum chamber 41: 8.0×10⁻⁵ Torr

Negative electrode current collector 19: roughened electrolytic copper foil with a length of 50 m, a width of 10 cm, and a thickness of 35 μm (available from Furukawa Circuit Foil Co., Ltd.)

Rewinding speed of negative electrode current collector 19 by rewinding roller 45 (transporting speed of negative electrode current collector 19): 2 cm/min

Raw material gas: not supplied

Targets 50a and 50b: silicon monocrystal with a purity 99.9999% (available from Shin-Etsu Chemical Co., Ltd.)

Acceleration voltage of electron beam: −8 kV

Emission of electron beam: 300 mA

The resultant negative electrode was cut to 40 mm×40 mm, to produce a negative electrode plate. Lithium metal was deposited on the surface of the thin-film negative electrode active material layer (silicon thin film) of this negative electrode plate. By depositing the lithium metal, the thin-film negative electrode active material layer was supplemented with lithium corresponding to the irreversible capacity in the initial charge/discharge.

The deposition of lithium metal was performed under an argon atmosphere, using a resistance heating deposition device (available from ULVAC, Inc.). A tantalum boat in the resistance heating deposition device was charged with lithium metal, and the negative electrode was fixed so that the negative electrode active material layer faced the tantalum boat. While the tantalum boat was supplied with a current of 50 A, deposition was performed in an argon atmosphere for 10 minutes to produce a negative electrode (not subjected to a corrugating process). In this way, a lithium ion secondary battery of the invention was produced in the same manner as in Example 1 except for the use of this negative electrode.

### COMPARATIVE EXAMPLE 1

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 16 sccm, the angle α to 70°, and the deposition time to 65 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery was produced in the same manner as in Example 1 except for the use of this negative electrode.

### COMPARATIVE EXAMPLE 2

In the same manner as in Example 1, a negative electrode active material layer was formed as an aggregate of columns formed on the surfaces of the protrusions on the surface of the negative electrode current collector, except that among the deposition conditions of the negative electrode active material, the oxygen flow rate from the nozzle was set to 60 sccm, the angle α to 36°, and the deposition time to 20 minutes. These columns were grown slantwise relative to the direction perpendicular to the surface of the negative electrode current collector. The thickness of the negative electrode active material layer was 20 μm, and the volume ratio A/B was 1.6 or more. Also, the composition of the compound constituting the negative electrode active material layer was SiO_{0.7}.

Next, under the same conditions as those of Example 1, lithium metal was deposited on the surface of the negative electrode active material layer, to produce a negative electrode (not subjected to a corrugating process). A lithium ion secondary battery was produced in the same manner as in Example 1 except for the use of this negative electrode.

### COMPARATIVE EXAMPLE 3

A lithium ion secondary battery was produced in the same manner as in Example 1 except that the production method of the negative electrode was changed as follows.

Mesophase microspheres graphitized at a high temperature of 2800° C. (hereinafter referred to as “mesophase graphite”) were used as the negative electrode active material. A negative electrode mixture slurry was prepared by stirring 100 parts by weight of this negative electrode active material, 2.5 parts by weight of SBR modified with acrylic acid (trade name: BM-400B, solid content 40% by weight, available from Zeon Corporation), 1 part by weight of carboxymethyl cellulose, and a suitable amount of water with a double-arm kneader. This negative electrode mixture slurry was applied onto a negative electrode current collector having a wavy sectional shape, dried, rolled, and cut to predetermined dimensions, to obtain a negative electrode.

### TEST EXAMPLE 1

### (1) Measurement of t1 and Pitch

The lithium ion secondary batteries produced in Examples 1 to 8 and Comparative Examples 1 to 3 were preliminarily charged under the following conditions. In the batteries of Examples 1 to 8 and Comparative Examples 1 to 2, the preliminary charge causes their negative electrodes to become wavy. Thus, after the preliminary charge, the batteries of Examples 1 to 8 and Comparative Examples 1 to 2 were disassembled, and their negative electrodes were taken out and observed with a scanning electron microscope. Their t1 and wave pitch (mm) were measured to obtain t1/t0. Table 1 shows the results.

Constant current charge: current; 12 mA, cut voltage; 4.1 V

Constant current discharge: current; 12 mA, cut voltage; 2.5 V cut

### (2) Nail Penetration Test

After the preliminary charge, the respective batteries were further charged under the following conditions, and a nail of 2.7 mm in diameter was penetrated therethrough at 5 mm/s in a 25° C. environment. Ten seconds after the nail penetration, the battery surface temperature was measured. Table 1 shows the results.

Constant current charge: current; 30 mA, cut voltage; 4.25 V

Constant voltage charge: current; 30 mA, voltage; 4.25 V, cut current; 3 mA

### (3) Evaluation of High-Power Characteristic

After the preliminary charge, the respective batteries were charged and discharged under the following conditions, and the ratio of the high-current discharge capacity to the low-current discharge capacity was evaluated. Table 1 shows the results.

TABLE 1

| | | | Shape of | | | Battery | |
|---|---|---|---|---|---|---|---|
| | | | negative | | | temper- | |
| | | Negative | electrode | | | ature | High- |
| | | electrode | active | | | upon nail | power |
| | | active | material | | Pitch | pene- | charac- |
| Battery | | material | layer | t₁/t₀ | (mm) | tration | teristic |
| Ex- | 1 | SiO_{0.7} | Slanted | 1.2 | 3 | 35 | 87.5 |
| ample | 2 | SiO_{0.7} | Slanted | 1.5 | 2.6 | 32 | 86.2 |
| | 3 | SiO_{0.7} | Slanted | 2 | 2.4 | 30 | 88 |
| | 4 | SiO_{0.7} | Slanted | 2.2 | 2.1 | 28 | 85.1 |
| | 5 | SiO_{0.7} | Slanted | 2.5 | 1.8 | 29 | 83.2 |
| | 6 | SiO_{0.7} | Slanted | 3 | 1.5 | 27 | 81.8 |
| | 7 | SiO_{0.7} | Zigzag | 2 | 2.7 | 30 | 85.3 |
| | 8 | Si | Thin film | 1.8 | 0.5 | 33 | 84.6 |
| Comp. | 1 | SiO_{0.7} | Slanted | 1.05 | 8.5 | 52 | 90.5 |
| Ex- | 2 | SiO_{0.7} | Slanted | 3.4 | 1.2 | 27 | 72.5 |
| ample | 3 | C | Layer | 1.02 | 11 | 57 | 86.8 |

In the nail penetration test, in Comparative Example 1 with the small t1/t0 ratio and Comparative Example 3 using the carbon negative electrode, the battery surface temperature after the nail penetration was high. This is probably because the low wave height increased the contact area of the positive electrode active material and the negative electrode active material upon the nail penetration. Also, as for Comparative Example 2 with the very high wave height, the high-power characteristic was low. This is probably because the high wave height made the distance between the positive and negative electrodes too large, thereby lowering the ionic conductivity and resulting in the low high-power characteristic.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. A negative electrode for a lithium ion secondary battery comprising:
a negative electrode current collector; and
a thin-film negative electrode active material layer formed on the negative electrode current collector,
wherein the ratio A/B of the volume A of the negative electrode active material layer in a charged state to the volume B of the negative electrode active material layer in a discharged state is 1.2 or more,
the negative electrode is shaped like waves in a section in the thickness direction, and
the ratio t1/t0 of the largest thickness t1 of the negative electrode to the smallest thickness t0 of the negative electrode is from 1.2 to 3.0.

2. The negative electrode for a lithium ion secondary battery in accordance with claim 1, wherein the wave pitch in the section of the negative electrode in the thickness direction is 0.3 to 3 mm.

3. The negative electrode for a lithium ion secondary battery in accordance with claim 1, wherein the smallest thickness t0 is 30 to 150 μm.

4. The negative electrode for a lithium ion secondary battery in accordance with claim 1, wherein the thin-film negative electrode active material layer includes a silicon-containing compound or a tin-containing compound.

5. The negative electrode for a lithium ion secondary battery in accordance with claim 1, wherein the thin-film negative electrode active material layer includes a plurality of columns containing a silicon-containing compound or a tin-containing compound.

6. The negative electrode for a lithium ion secondary battery in accordance with claim 5, wherein the plurality of columns extend outwardly from a surface of the negative electrode current collector and are spaced apart from one another.

7. The negative electrode for a lithium ion secondary battery in accordance with claim 5, wherein the columns extend in a direction perpendicular to a surface of the negative electrode current collector or extend slantwise relative to the direction perpendicular to the surface of the negative electrode current collector.

8. The negative electrode for a lithium ion secondary battery in accordance with claim 5, wherein each of the columns is a laminate of particles containing the silicon-containing compound or the tin-containing compound.

9. The negative electrode for a lithium ion secondary battery in accordance with claim 4, wherein the silicon-containing compound is one or more selected from the group consisting of silicon, silicon oxides, silicon nitrides, silicon-containing alloys, and silicon compounds.

10. The negative electrode for a lithium ion secondary battery in accordance with claim 4, wherein the tin-containing compound is one or more selected from the group consisting of tin, tin oxides, tin nitrides, tin-containing alloys, and tin compounds.

11. A lithium ion secondary battery comprising: a positive electrode capable of absorbing and desorbing lithium; the negative electrode for a lithium ion secondary battery of claim 1; a separator, and a non-aqueous electrolyte.
